(19) United States
(12) Patent Application Publication
(10) Pub. No.: US 2002/0177463 A1
(43) Pub. Date: Nov. 28, 2002

(54) Two unit portable cellular phone system

(76) Inventor: Armando Ruiz, Miami, FL (US)

Correspondence Address: Barry J. Schindler, 499 Park Avenue, New York, NY, 10022, US

(21) Appl. No.: 09/862,807

(22) Filed: May 22, 2001

(51) Int. Cl. H04M 1/00

(52) U.S. Cl. 455/550

(57) ABSTRACT

The present invention relates to a portable cellular phone system comprising: two units; unit 1 comprising a microphone, display, keypad, battery and speaker; unit 2 comprising an antenna for transmitting and receiving RF signals from a wireless communication system, and a receiver portion for converting the RF signal into data signals; unit 1 is not capable of transmitting or receiving RF signals from a wireless communication system; and units 1 and 2 having wireless devices for transmitting and receiving data signals between units.

### BACKGROUND OF THE INVENTION

With the recent development of an advanced information-intensive society, the use of electric waves over various frequency bands is rapidly increasing in such areas as multi-channel access systems and mobile communication equipment typified by cellular phones. However, there is a belief in the scientific community that exposure to electromagnetic radiation can have debilitating effects on humans. For example, it is believed that exposure to electromagnetic radiation from a cellular phone held up to the head may cause debilitating effects on the human brain. It is also believed that the effects are most pronounced when the exposure is protracted and at high radiation levels, however lesser degrees of exposure may also cause illness and even death. It is therefore desirable to protect people from the adverse effects of electromagnetic radiation by in some way shielding or blocking the radiation before it reaches a person. Conventionally, the most simple and direct method of protection is to simply install a physical shield between the electromagnetic radiation source and the person. The shield is typically made of metal which absorbs and blocks the electromagnetic radiation and thereby protects the person. Examples of this technology include the lead pads used during X-ray diagnosis, and the mesh screen in the door of a microwave oven.

Conventionally, EMI control is accomplished by re-designing the electronic computing device with EMI techniques in mind. For example, making the housing of the electronic computing device a shielded box, using a dedicated circuit board layer as the ground-plane, using a ground-plane area underneath the wireless communication module, or modifying the electronic circuit design to reduce the EMI emissions from the electronic computing device. However, it is believed that these methods still do not totally shield a human from the debilitating effects of electromagnetic radiation.

### DETAILED DESCRIPTION OF THE INVENTION

The present invention comprises two or more units for a cellular phone. As such, the present system may completely isolate a human from the debilitating effects of electromagnetic radiation. In one embodiment of the present invention, the present system comprises two units—unit 2 comprises an antenna and corresponding circuitry for transmitting outgoing calls and receiving incoming call. Specifically, unit 2 receives transmissions from a wireless communication system on at least one radio frequency (RF) channel. It will be appreciated that the wireless communication system may function utilizing any wireless RF channel, for example, a one or two-way pager channel, a mobile cellular channel, or a mobile radio channel. Similarly, it will be appreciated that the wireless communication system may function utilizing other types of wireless channels such as infrared channels. In the following description, the wireless communication system refers to any of the wireless communication systems mentioned above or an equivalent.

In one embodiment, unit 2 may be composed of: what is referred in the industry as a “mother board” (e.g. central processing unit); antenna; battery; on/off switch; light; and/or emitting diodes for visual on and off. The antenna is used to transmit and receive RF signals. Upon receiving signals, the antenna converts the signals into electrical RF signals and transfers the signals to a receiver portion of the unit 2. The receiver portion of unit 2 demodulates the received electrical RF signals, converts the demodulated RF signals into data signals, and couples the data signals to the processor and switching circuit. The received data signals, which are now usable by the unit 2, may contain voice data.

In addition, unit 2 also includes a method of transmitting and receiving the data signals to and from unit 1. Methods of transmitting between units 1 and 2 include, but are not limited to, blue tooth technology, low power FM, 900 MHz or 2400 MHz. In one embodiment, unit 1 comprises a keypad, a display, speaker and microphone, “motherboard”, battery and a transmitter device for communicating with unit 2.

Consequently, the purpose of the two unit system of the present invention is to move unit 2 having the antenna system for receiving RF signals with its accompanying harmful electromagnetic radiation further from the user's head but still allow unit 1 to be a typical cellular phone with all its corresponding features. Thus, for the user's perspective, unit 1 acts like a conventional cellular telephones—the user interface, which may include a microphone, a display, a keypad, and/or a speaker. However, an advantage of the present system is that units 1 and 2 may be of a compact size (e.g. credit card size) because many of the functions have been split into two parts. For example, unit 2, which does not need a microphone, a display, a keypad, and/or a speaker, may be ultra thin. However, in another embodiment, unit 2may also include a display (e.g. LCD) for displaying information such as caller ID.

In yet another embodiment, one connector may be used to recharge the batteries of units 1 and 2. For example, after a user has finished using the units, unit 1and 2 may be installed in one battery charger.

In a further embodiment, unit 2may be remotely located from unit 1such as being in the trunk of a car, glove compartment, women's purse, worn on the clothing etc.

In one embodiment, unit 1comprises a plurality of keypad openings and are disposed on the raised, front outer surface below the display opening. Extending upward from beneath the raised, front outer surface and through the plurality of keypad openings are a corresponding plurality of actuatable keys. The plurality of actuatable keys may be backlit to permit convenient operation of unit 1at night or in the dark. The plurality of actuatable keys comprises a portion of a keypad circuit that may include conventional telephone keys (0, 1, 2, . . . , 9, *, and #) and functional keys (such as recall (RCL), store (STO), power on/off (PWR), function (FCN), clear (CLR), volume up ( ), volume down (v), send (SND), and end (END)) for operating unit 1. The keypad circuit is used to initiate and, typically, receive a call. When initiating a call, the user enters the number to be called by actuating the appropriate keys of the keypad circuit. The user subsequently actuates the key designated “SND,” which effectively outputs the number to establish communication. When receiving a call, the user also actuates the key designated “SND” to take unit 1off-hook and, thus, receive the incoming call.

In yet another embodiment, unit 2may include at least one retaining trough, clip-on, loops or equivalent device for securing unit 2to a belt, edge of pants, other part of clothing, purse or briefcase. In another embodiment, unit 1may clip into unit 2, which is in the shape of a cradle (e.g. holster).

In a further embodiment, unit 2may include a conventional radiation shield. In one specific embodiment, a radiation shield is disposed between a radiation component and one or both units of the present invention to prevent unwanted exposure of the user to emanating radiation from the radiation emanating component. Specifically, the shield device protects a user by blocking the passage of microwaves to and from the cellular phone antenna while the phone is in use. The radiation emanating component is the internal or external antennas. The radiation shield may be retrofitted to fit either or both units, or may be designed specific for either or both units. The radio shield can absorb, block, and/or reflect electromagnetic wave radiation to shield the user of such cellular telephones from unwanted and possibly harmful exposure to electromagnetic wave radiation.

In another embodiment, the shield device comprises a rectangular shaped body with an upper tab for attaching the shield device to the antenna and two opposing lower tabs for attaching the shield device to the upper portion of the cellular phone. The shield device consists of a cover with a pocket for receiving the shielding member. In yet another embodiment of the invention, the shield device may be a semi-circular hollow tubular member adapted to fit over an antenna. The tubular member has an elastic bottom portion adapted to fit firmly over the antenna ferrule. The bottom portion of the tubular member consists of a resilient disk member, thus protecting the user from any microwaves emitted and received by the antenna.

In yet another embodiment, the shielding device used on unit 2of the present invention comprises a substantially rectangular shield that extends adjacent to the antenna. A downwardly extending slide arm portion of the shield terminates in a substantially pointed end surface formed by the outer edge of the shield sloping inwardly to engage the inner edge of the slide arm, with the outer edge having a notch on the exterior surface thereof. In a further embodiment, the shielding member on unit 2extends between the antenna of the telephone and a user and configured to encompass the antenna on three sides. Alternatively, the shielding member is made up of a metal strip placed between the antenna rod of the telephone and the speaker. The strip has a flat body portion and an upper portion that is curved away from the rod. Overall length of the strip is slightly longer than the antenna rod, and its width is 1 to 1.5 inches.

In one embodiment, the radiation shield may be composed of a RF shielding material of any conventional electric wave absorbing materials. The material is such that electromagnetic waves coming from outside are reflected and thereby prevented from propagation into the electronic apparatus or part thereof to be protected or, alternatively, electromagnetic waves coming from inside are reflected such that they will not radiate out of the electronic apparatus or part thereof. Electric wave absorbing materials are such that the incident electric waves are converted to thermal energy so that the intensity of their transmission or reflection is reduced markedly.

In one embodiment, ferrites or carbon may be used as electric wave absorbing materials. In a specific embodiment, sintered ferrites are effective at comparatively low frequencies such as those in the VHF band whereas carbon is effective at comparatively high frequencies. Both ferrites and carbon can be used as mixtures, or dispersions in organic substances such as rubbers or plastics; in this case, the absorption characteristics can be controlled by adjusting the content of the electric wave absorber or by using more than one electric wave absorber. In a further example, carbon-based electric wave absorbers may be used as such mixtures and incorporate carbon black and/or graphite particles.

Other suitable materials that are effective as absorbers of electric waves include, but are not limited to, aluminum, lead, zinc, titanium, lithium, stainless steel, silver, copper and fibers. In particular, PZT (lead zirconate titanate) and PLZT (lead lanthanum zirconate titanate) may be effective in absorbing electric waves at frequencies in the GHz band; however, the amount by which these materials can be dispersed or incorporated in plastics is limited by various factors including the melt viscosity of the plastics used, their processability, the mechanical strength, brittleness and adhesion of fibers, films, sheets and other shaped parts of the plastics in which those metals are dispersed or incorporated.

In another embodiment, either or both units of the present invention may be jacketed or encased with conventional EMI shields rather than electric wave absorbers. Suitable methods currently employed to form EMI shields over suitable surfaces of plastic jackets or cases include, but are not limited to, the application of conductive paints, metal-arc spraying, vacuum metallizing, evaporating, cladding, and deposition of metal layers (by electroplating or electroless plating). In one specific embodiment, primer paints are applied to form undercoats which, in turn, are overlaid with EMI shields. The primer paints typically contain metal particles as a film-forming component.

What is claimed:

1. A portable cellular phone system comprising:
two units;
unit 1comprising a microphone, display, keypad, battery and speaker;
unit 2comprising an antenna for transmitting and receiving RF signals from a wireless communication system, and a receiver portion for converting the RF signal into data signals;
unit 1is not capable of transmitting or receiving RF signals from a wireless communication system; and
units 1 and 2 having wireless devices for transmitting and receiving data signals between units.

2. The portable cellular phone of claim 1 further including unit 2having a second microphone and a second speaker.

3. The portable cellular phone of claim 1 wherein unit 1further includes an outer surface, the outer surface including:
a first opening for the microphone;
a second opening for the speaker;
a third opening, the display positioned at the third opening;
a plurality of openings disposed adjacently to the third opening; and
a plurality of actuatable keys extending through the plurality of openings, the plurality of actuatable keys being positioned below the display such that the display remains unobstructed during actuation of the plurality of actuatable keys.

4. The portable cellular phone of claim 3 wherein unit 2includes a radiation shield.

5. The portable cellular phone of claim 4 wherein unit 2includes an attachment device selected from the group consisting of a retaining trough, clip-on, and loop.

6. The portable cellular phone of claim 4 wherein the radiation shield is composed of a RF shielding material.

7. The portable cellular phone of claim 4 wherein the device for transmitting and receiving data signals between units transmits with the group selected from blue tooth technology, low power FM, 900 MHz and 2400 MHz.
